(19) United States
(12) Patent Application Publication
(10) Pub. No.: US 2007/0188403 A1
(43) Pub. Date: Aug. 16, 2007

(54) Device and method for displaying information

(76) Inventors: Mats Johansson, Malmo (SE); Ben Lindgren, Bara (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/584,885

(22) PCT Filed: Dec. 27, 2004
(86) PCT No.: PCT/SE04/02014

§ 371 Date: Feb. 6, 2007

(30) Foreign Application Priority Data
Dec. 30, 2003 (SE) 0303598-7

(51) Int. Cl. G09G 5/00

(52) U.S. Cl. 345/1.1

(57) ABSTRACT

A device for displaying information, comprising at least one display stand (10) and a transfer unit (17) wirelessly connected to associated display stands. The display stand supports a plurality of displays (11) positioned adjacent to one another, and comprises a control unit (16). The control unit (16) comprises communication means (34) for communication with the transfer unit, memory means (33) for storing information to be shown during at least one display sequence and a drive unit (36) for the displays (11). The control unit (16) is arranged for transferring different information to different sets of displays simultaneously for simultaneous showing on the displays. The transfer unit is arranged for intermittently transferring information corresponding to a display sequence to any display stands associated with the transfer unit. The invention also relates to a system for displaying information on a plurality of sites, comprising a central storing unit (24) and at least one display stand (10) on each site. The central storing unit is connected to at least one transfer unit (17), being arranged to establish contact with the central storing unit (24) intermittently to retrieve information.

### FIELD OF THE INVENTION

In shops and similar establishments and environments there is a need to inform customers and passers-by about product and service offers. The invention relates to a device for displaying information, comprising at least one display stand and a transfer unit wirelessly connected to associated display stands. The device can also be part of a system for displaying information on a plurality of sites, wherein the system comprises a central server and at least one display stand on each site.

### PRIOR ART

Printed material in the form of advertising posters and similar has been known for a long time. Lately, different types of displays have occurred, which easily can be updated and also show moving pictures. Displays showing price information are known as well as displays showing information films about the use of products.

Previously occurring displays and display systems have shortcomings when it comes to effectively conveying both advertising messages and more tangible information, such as price. Consequently, there is a need for improvement of the displays and systems used today.

### SUMMARY OF THE INVENTION

An object of the invention is to avoid the above-mentioned disadvantage and provide a device for displaying information. The device comprises a display stand having a plurality of displays, e.g. in the form of flat LCD screens with colour reproduction. The display stand comprises a control unit providing different displays with different information for simultaneous display. A first group of displays, e.g. two displays, can show price information and any other information.

A second group, which also can comprise two displays, can display an advertising message, e.g. in the form of a commercial shown also in other contexts. By simultaneously showing both types of information and showing them in a direct connection to each other, conveying of information to customers and by-passers is rendered more effective. Information of different display sequences can be shown one after the other. The length and content of the sequences can be chosen freely depending on the present application.

The control unit is wirelessly connected to a transfer unit, which intermittently provides the control unit with data corresponding to the information to be shown. Inside the control unit communication means are arranged for wireless transmission of information, and memory means for storing the information to be shown during at least one display sequence. The control unit also comprises the necessary drive circuits and similar for the displays.

The display stands can be arranged for stationary mounting close to the point of sale of the products the information refers to. According to such an embodiment the displays are suitably arranged side by side. According to another embodiment the display stand is mobile and comprises a pole supporting the displays being arranged in a row one above the other. Particularly for the mobile embodiment, it is advantageous that all communication with the transfer unit is wireless, since no wiring to the display stand is required.

According to a first embodiment of the invention the transfer unit is arranged in the same premises as the display stands, or at least in the vicinity thereof. The transfer unit comprises communication means for intermittently and independently contacting and transferring information to and from a central storing unit. Suitably, communication between the transfer unit and the central storing unit is performed via the Internet. At least one set of the information to be shown during a display sequence in a plurality of display stands in different premises is stored in the central storing unit.

A transfer unit is arranged in each room provided with display stands and the transfer unit provides the control unit of each display stand with information to be shown. The control unit is passive in the sense that it does not actively contact the transfer unit. Instead a file transfer system having a powerful encryption is used. A conventional TCP/IP protocol can be used with a wire connection but preferably a wireless network, a so called WLAN (Wireless Local Area Network), is used.

The control unit is arranged to independently and continuously show different information sequences on the displays of the display stand. The showing can continue and can follow a scheme determined by the transfer unit, even though the connection with the transfer unit is interrupted.

According to a second embodiment of the invention the transfer unit is separated from the display stand and can be arranged together with the central storing unit. According to this embodiment the display stands are provided with communication means for telecommunication with the transfer unit. The telecommunication means can comprise a mobile phone or a corresponding device, and the transfer can be performed by means of GPRS (General Packet Radio Service) or any other corresponding wireless telecommunication interface.

A practical embodiment of the display stand comprises a base plate and a pole projecting from said base plate. The pole can be formed as an elongated light metal profile. A longitudinal groove is arranged in the light metal profile, in which groove a strip can run. The displays of the display stand are arranged on the strip and, thus, can be moved up and down to suitable height. The strip is provided with a lock device for locking the strip at the desired height.

### SHORT DESCRIPTION OF THE DRAWINGS

The invention will now be more closely described using embodiments referring to appended drawings, in which

FIG. 1 schematically illustrates a device for displaying information according to a first embodiment of the invention,

FIG. 2 schematically illustrates a device for displaying information according to a second embodiment of the invention,

FIG. 3 is a block diagram illustrating the technical functions of the device of FIG. 1,

FIG. 4 schematically shows a device for displaying information according to a third embodiment of the invention, and

FIG. 5 is a block diagram illustrating the technical functions of the device of FIG. 4,

### THE INVENTION

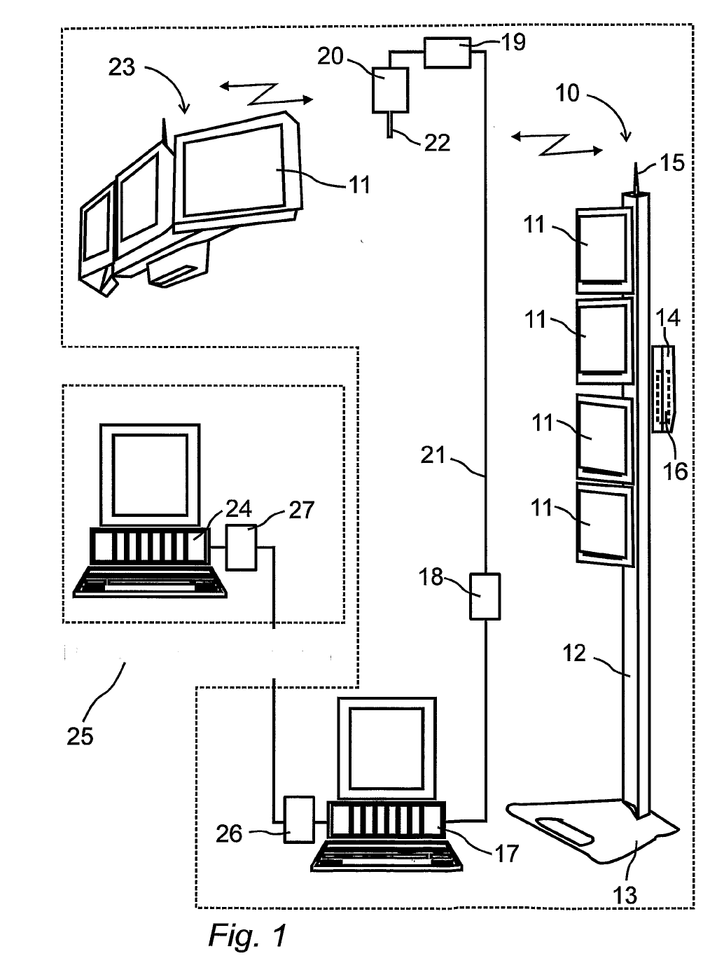

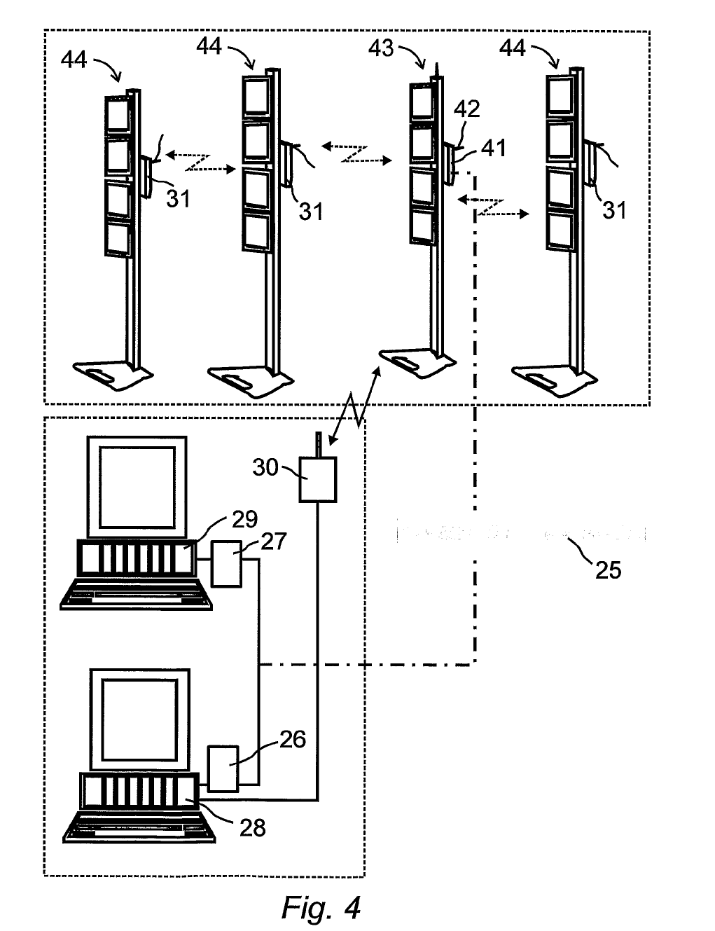

According to the embodiment of FIG. 1 a mobile display stand 10 comprises four displays 11 arranged in a row, one above the other, on a pole 12. The displays 11 are mounted on a strip being displaceable along the longitudinal direction of the pole. A bottom end of the pole is fastened to a carrying means and supporting means 13, being a base plate 13 in the embodiment as shown. One embodiment of the pole and the strip is disclosed below with reference to FIG. 4. The base plate can be provided with wheels (not shown). Suitably, the wheels are then arranged to be in contact with the floor when the pole is inclined. Transport of the pole is thus facilitated, without impairing the stability thereof when standing.

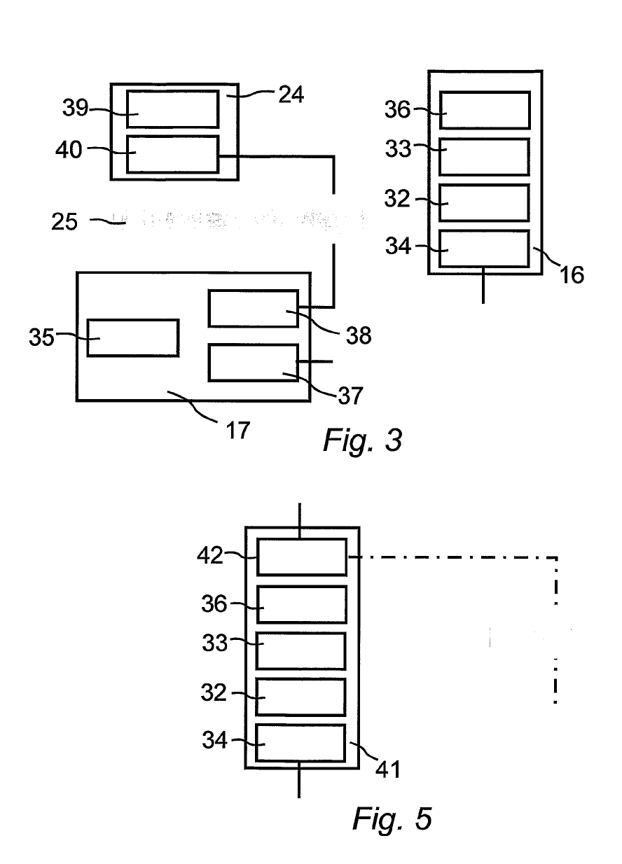

A box 14 and an antenna 15 are also arranged on the pole 12. A control unit 16 is arranged inside the box. The control unit 16 is connected to the antenna 15 and the displays 11 of the display stand 10. The control unit 16 is described further below with reference to FIG. 3. Preferably, the displays 11 are of a colour LCD type. Loudspeakers (not shown) are arranged integrated with the displays 11 or as separate loudspeakers fastened to the pole. A display stand having this configuration can be called a player.

A transfer unit 17, which can be arranged as a conventional computer, is connected to a communication link 20 through a base unit 18 and a terminal unit 19. A conventional network cable (LAN) 21 connects the base unit 18 and the terminal unit 19. The communication link 20 can be a conventional unit for wireless network communication (WLAN) and also comprises an antenna 22.

A stationary display stand 23 can be arranged as a complement or as an alternative to the mobile display stand. Except for the pole and the base plate the stationary display stand 23 comprises the same components as the mobile display stand 10.

The transfer unit 17 is connected to a central storing unit 24. The central storing unit 24 can comprise a conventional computer and is set to store those display sequences to be displayed on the different display stands. The display sequences are available as computer files to be retrieved by different transfer units. In the embodiment of FIG. 1 the transfer unit 17 and the central storing unit 24 are separated from each other and communicate through the Internet 25 or a similar network. For security reasons the transfer unit 17 can be connected to the Internet through a first firewall 26, and the central storing unit 24 can be connected to the Internet correspondingly through a second firewall 27.

Display sequences and films are loaded through a central studio unit, in which display schemes for different display sequences also are stored. When a display scheme has been completed it can be transferred to the central storing unit 24, from which transfer units 17 can retrieve them. According to the shown embodiment the central studio unit is a part of the central storing unit 24. However, it is possible to provide the central studio unit as a separate computer.

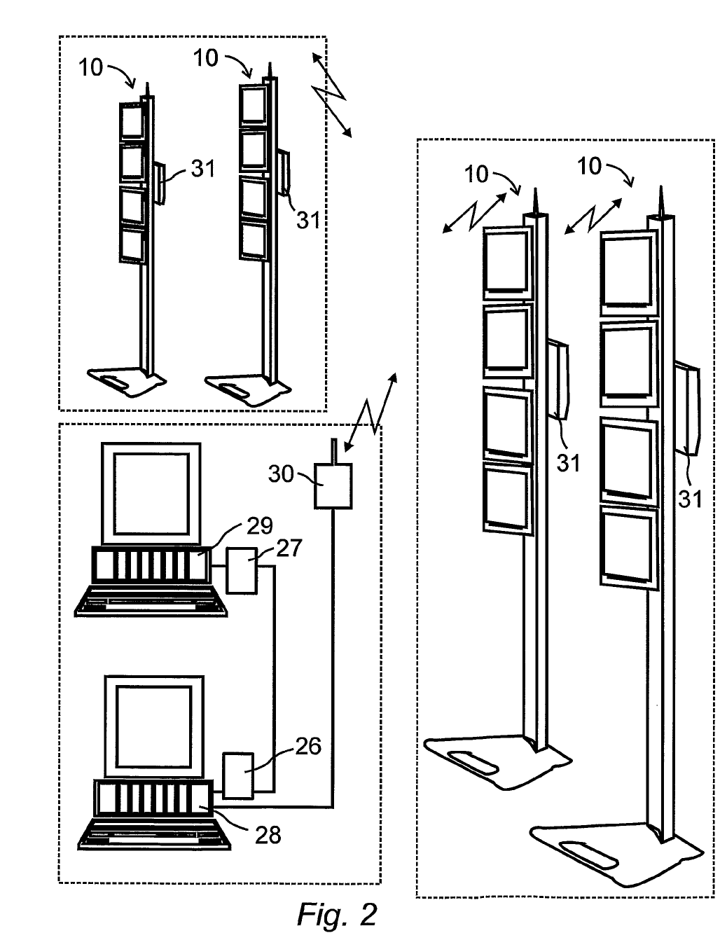

In the embodiment of FIG. 2 a transfer unit 28 is arranged together with a central storing unit 29. This embodiment of the transfer unit 28 communicates with display stands 10; 23 through a wireless telecommunication system, such as GPRS or any other corresponding wireless telecommunication interface. According to the shown embodiment the wireless telecommunication system comprises a device for mobile telecommunication 30, e.g. in the form of a mobile phone. The display stands 10; 23 are provided with a corresponding wireless telecommunication system, suitably being arranged together with a control unit 31 included in the display stand.

FIG. 3 shows by means of a block diagram how different units can be arranged. The control unit 16 comprises a computer 32 having memory means 33. A WLAN client 34, or a corresponding unit, communicates with the transfer unit 17 to receive the display sequences shown on the displays 11. The computer 32 executes a file transfer service, a so called FTP service (File Transfer Protocol), which receives films, display sequences and commands from the transfer unit 17 by means of a TCT/IP protocol.

The control unit can execute its functions even though contact with the transfer unit is interrupted, functions such as playing films and starting and stopping on preset times. The control unit also comprises drive means and control means 36 for the displays connected to the control unit. According to one embodiment a control unit is integrated in each display.

A transfer unit 17 comprises a computer 35 buffering display sequences and other data for the display stands having control units 16 and being associated with the transfer unit 17. The communication between the control unit and the transfer unit is LAN and WLAN and is protected by SSH2 encryption during login as well as during file transfer. A WLAN connection point (Access point) 37 is used for communication with the control unit of the display stand.

The computer 35 transfers all films and retrieves statistics on the control unit. This communication is initiated by the transfer unit between preset intervals. The transfer unit monitors all connected control units and maintain the correctness of date, time and any other relevant information.

In turn, the transfer unit retrieves films and commands from the central storing unit 24 in specific intervals. The communication between the transfer unit 17 and the central storing unit 24 is LAN through a first network unit 38, which normally is performed over the Internet and therefore is adapted to be able to pass through firewalls. All files and file names are encrypted, e.g. according to Rijndeal.

The central storing unit 24 comprises a computer 39 executing a FTP service where the transfer unit 17 can retrieve display sequences and films and deliver statistics. Here, also the central studio unit can deliver films and retrieve statistics. The communication between the central storing unit 24 and the transfer unit 17 is performed through a second network unit 40.

As mentioned above the central storing unit 24 and the transfer unit 17 can be arranged together. According to such an embodiment the transfer unit also comprises telecommunication means, e.g. a mobile phone or similar device.

The third embodiment according to the invention, as shown in FIG. 4, comprises a transfer unit 28 and a central storing unit 29 arranged together therewith. According to the invention these units can also be combined in a computer, or any corresponding unit. The units, respectively, are protected in a conventional manner by means of a first firewall 26 and a second firewall 27. In the embodiment shown, the transfer unit 28 is connected to a device 30 for mobile telecommunication and through it to a developed control unit 41 of a master display stand 43 according to the invention. An alternative to this communication path is a connection through the Internet 25. Such a connection is indicated by a dash and dot line. The master display stand 43 comprises at least one display 11 for displaying information, which is transferred from the central storing unit 29. The master display stand 43 can be provided with a number of displays different from the other display stands. For example, the master display stand 43 can be arranged with a single display.

The developed control unit 41, see also FIG. 5, comprises a computer 32, memory means 33, a WLAN-client 34 and drive means and control means 36, similar to the control unit 16. In addition the developed control unit 41 comprises means 42 for external telecommunication. The means 42 can be adapted to mobile telecommunication and can be based on GSM, GPRS, 3G or any other corresponding wireless communication system. Both master display stands 43 and subordinate display stands 44 can be formed with or can comprise a developed control unit 41. Also the embodiments of display stands 10 as described above can be arranged with a developed control unit 41 to obtain a more flexible structure.

The means 42 for mobile telecommunication, or a wire-connected system communicating with the transfer unit 28, of one of the display stands and more specific in this embodiment the master display stand 43, is activated. Accordingly, an outer communication can be established for transferring information from the central storing unit 29. Remaining display stands, in which means 42 for mobile telecommunication, if any, not has been activated, lack in this condition this possibility to outer communication.

Activation of the means 42 for external telecommunication also bring other functions of the master display stand 43 to be activated. The master display stand 43 can, inter alia, operate as a server and as a bridge towards the remaining display stands. The master display stand 43 cooperates with at least one subordinate display stand 44 in a master-slave network. This means that a subordinate display stand 44 communicates outwards and obtains the information to be displayed through the master display stand 43. Communication between the master display stand 43 and one or more subordinate display stands 44 is performed by means of the WLAN-clients 34 of the display stands.

Hence, the master display stand 43 operates both as a display stand like others for displaying the current, transferred information and as a bridge for the other subordinate display stands 44 arranged on the site. All the display stands can be arranged with substantially the same set of hardware and can thus operate as master display stands as well as subordinate display stands. A display stand being activated in respect of external communication then plays the role of the master display stand.

1. A device for displaying information, comprising at least one display stand (10) and a transfer unit (17) wirelessly connected to associated display stands, characterised in
that said display stand supports a plurality of displays (11) positioned adjacent to one another,
that said display stand comprises a control unit (16) common to all displays of the display stand,
that the control unit (16) comprises communication means (34) for communication with the transfer unit, memory means (33) for storing information to be shown during at least one display sequence, and a drive unit (36) for the displays (11),
that the control unit (16) is arranged for transferring different information to different sets of displays simultaneously for simultaneous showing on the displays, and
that the transfer unit is arranged for intermittently transferring information corresponding to a display sequence to any display stands associated with the transfer unit.

2. A device as claimed in claim 1, wherein the communication means (34) comprises a WLAN-client.

3. A device as claimed in claim 2, wherein the transfer unit (17) comprises a computer (35), a WLAN connection point (37) and a first network unit (38).

4. A device as claimed in claim 1, wherein the display stand (10) comprises an elongated pole (12) projecting from a base plate (13) and wherein the displays (11) are connected to a strip (45) being displaceable along the pole (12), so that the displays are arranged in a row one above the other.

5. A device as claimed in claim 4, wherein the display stand comprises four displays (11) and wherein the displays (11) are connected to the control unit (16) two by two, so that the control unit provides two adjacent displays with a first display sequence and the two remaining displays with a second display sequence.

6. A system for displaying information on a plurality of sites, comprising a central storing unit (24) and at least one display stand (10) on each site, characterised in
that the central storing unit (24) is connected to at least one transfer unit (17),
that the transfer unit (17) is arranged for establishing contact with the central storing unit (24) intermittently to retrieve information,
that the display stand (10) supports a plurality of displays (11) arranged adjacent to one another,
that the display stand (10) comprises a control unit (16) common to all displays of the display stand,
that the control unit (16) comprises communication means (34) for communication with the transfer unit (28), memory means (33) for storing information to be shown during at least one display sequence, and drive units (36) for the displays (11),
that the control unit is arranged for transferring different information to different sets of displays simultaneously for simultaneous showing on the displays, and
that the transfer unit is arranged for intermittently transferring information corresponding to a display sequence to associated display stands.

7. A system as claimed in claim 6, wherein the central storing unit (24) is connected to the transfer unit (17) through network units (38; 40) and the Internet and wherein the transfer unit (17) is connected to at least one control unit (16) through WLAN-clients.

8. A system as claimed in claim 6, wherein the central storing unit (24) is connected to the transfer unit (17) through network units (38; 40) and wherein the transfer unit (17) is connected to a plurality of separated control units (16) through a wireless telecommunication interface.

9. A system as claimed in claim 6, wherein the central storing unit (24) comprises a file transfer protocol (FTP) for providing information in the form of display sequences, and wherein the transfer unit (17) is arranged to intermittently retrieve the information through the file transfer protocol.

10. A system as claimed in claim 6, wherein the transfer unit (17) comprises a database for providing information in the form of display sequences, and wherein the transfer unit (17) is arranged to intermittently transfer the information to the control unit (16) through a file transfer protocol.

11. A system as claimed in claim 10, wherein the control unit (16) is arranged for independently activating and driving displays (11) associated with the control unit (16) in the interval between the moments of transfer of information from the transfer unit (17) to the control unit (16).

12. A system for displaying information on a plurality of sites, comprising a central storing unit (29) for storing information, a transfer unit (28) connected to the central storing unit (29), and at least one display stand (10; 43; 44) on each site, characterised in
that the display stand (10) supports at least one display (11) for showing information stored in the central storing unit (29),
that a control unit (41) comprises communication means (42) for external communication with the transfer unit (28), memory means (33) for storing information to be shown during at least one display sequence, and a drive unit (36) for the display,
that the control unit (41) comprises means (34) for internal communication with a corresponding control unit (41) of at least one other display stand being positioned on the same site,
that the control unit (41) is arranged to enter a bridge mode for remaining display stands on the site upon activation of the communication means (42) for external communication, and thereby allow communication between the remaining display stands and the transfer unit (28).

13. A system as claimed in claim 12, characterised in that the display stand (10; 43 44) comprises a control unit (41) common for all displays of the display stand.

14. A system as claimed in claim 12, characterised in that the control unit is arranged for transferring different information to different sets of displays simultaneously for simultaneous showing on the displays.

15. A system as claimed in claim 12, characterised in that the transfer unit is arranged for intermittently transferring information corresponding to a display sequence to associated display stands.

16. A system as claimed in claim 12, characterised in that the display stand (10) supports a plurality of displays (11) positioned adjacent to one another.
